(19) United States
(12) Patent Application Publication
(10) Pub. No.: US 2016/0350034 A1
(43) Pub. Date: Dec. 1, 2016

(54) IMAGE FORMING APPARATUS, IMAGE FORMING SYSTEM AND IMAGE FORMING METHOD

(71) Applicant: KYOCERA Document Solutions Inc., Osaka (JP)

(72) Inventors: Takashi MURAKAMI, Osaka (JP); Ryusuke NAKATANI, Osaka (JP); Yosuke NAKAZATO, Osaka (JP); Kazuki DOZEN, Osaka (JP); Makoto KOWAKA, Osaka (JP)

(73) Assignee: KYOCERA Document Solutions Inc., Osaka (JP)

(21) Appl. No.: 15/158,295

(22) Filed: May 18, 2016

(30) Foreign Application Priority Data
May 25, 2015 (JP) 2015-105036

(51) Int. Cl. G06F 3/12; H04N 1/00

(52) U.S. Cl. CPC G06F 3/1222; G06F 3/1205; G06F 3/1207; G06F 3/1211; H04N 1/00411; H04N 2201/0094; H04N 2201/0081

(57) ABSTRACT

There are provided an image forming apparatus that separately outputs print products to a plurality of trays and reduces problems caused by browsing and editing of data on the use of the trays, an image forming system that utilizes the image forming apparatus through a network and an image forming method. In the image forming apparatus, one of the trays is selected, the print product is output and tray information for determining a tray with a combination between an instructor and a recipient. The tray information can be browsed and edited only by the instructor, and thus the problem is reduced. A receipt information display portion that displays a list of trays to which print products are output is included to maintain the convenience of users. An image forming system using two or more image forming apparatuses is formed with a management server.

This application is based upon and claims the benefit of priority from the corresponding Japanese Patent Application No. 2015-105036 filed on May 25, 2015, the entire contents of which are incorporated herein by reference.

### BACKGROUND

The present disclosure relates to an image forming apparatus, an image forming system that utilizes the image forming apparatus through a network and an image forming method.

An instructor who instructs an image forming apparatus to output a print product may be different from a recipient who uses the print product. Although in general, the instructor collects the print product from the image forming apparatus and delivers it to the recipient, it is often convenient that the recipient collects the print product from the image forming apparatus.

The recipient does not always collect the print product immediately after the output, and the print product is often left in the image forming apparatus. When a plurality of print products are left in the image forming apparatus, in order to prevent them from being mixed, an image forming apparatus having a plurality of trays to which the print products are output is used, and the trays are used separately.

For example, a typical image forming apparatus is known in which when an instructor specifies a recipient, and a print product is output, the print product is output to the tray that is allocated to the recipient, and a notification is provided to the recipient by mail.

The typical image forming apparatus described above inevitably holds, as data, correspondences between recipients and trays. The data can be browsed and edited by a large number of users. Hence, when one user erroneously edit the data, all the uses are affected. For example, a large number of users know which tray is allocated to a recipient who receives a top-secret print product. Hence, there is a problem in security.

### SUMMARY

According to a first aspect of the present disclosure, there is provided an image forming apparatus that includes a plurality of trays, an output control circuit, a storage circuit and a tray determination circuit. The output control circuit selects one of the trays and outputs a print product. The storage circuit stores tray information for determining a tray with a combination between an instructor who provides an instruction of printing and a recipient who receives the print product. The tray determination circuit determines, with the tray information, the tray to be selected by the output control circuit.

According to a second aspect of the present disclosure, there is provided an image forming system including one or two or more image forming apparatuses and a management server. The image forming apparatus includes: a plurality of trays; and an output control circuit that selects one of the trays and outputs a print product. The management server includes: a print instruction circuit that specifies one of the image forming apparatuses and one of the trays in the one image forming apparatus and instructs the one image forming apparatus to perform printing; a storage circuit that stores tray information that corresponds to an image forming apparatus and a tray corresponding to a combination between an instructor who provides an instruction of the printing and a recipient who receives the print product; and a tray determination circuit that determines, with the tray information, the image forming apparatus and the tray to be specified by the print instruction circuit. The output control circuit outputs the print product according to the instruction provided by the print instruction circuit.

According to a third aspect of the present disclosure, there is provided an image forming method including: using the management server to control one or two or more image forming apparatuses so as to select one of the trays and output the print product; determining the tray to be selected by the output control circuit with the tray information that indicates the image forming apparatus and the tray corresponding to the combination between the instructor who provides the instruction of the printing and the recipient who receives the print product; and outputting the print product according to the instruction provided by the print instruction circuit.

### BRIEF DESCRIPTION OF THE DRAWINGS

FIG. 1 shows the appearance of an image forming apparatus;

FIG. 2 shows the configuration of the image forming apparatus;

FIG. 3 shows an example of user information;

FIG. 4 shows an example of tray information;

FIG. 5 shows an example of a destination setting screen;

FIG. 6 shows an example of a receipt information display screen;

FIG. 7 shows the configuration of an image forming system; and

FIG. 8 shows the details of the image forming system.

### DETAILED DESCRIPTION

Embodiments of the present disclosure will be described below.

### First Embodiment

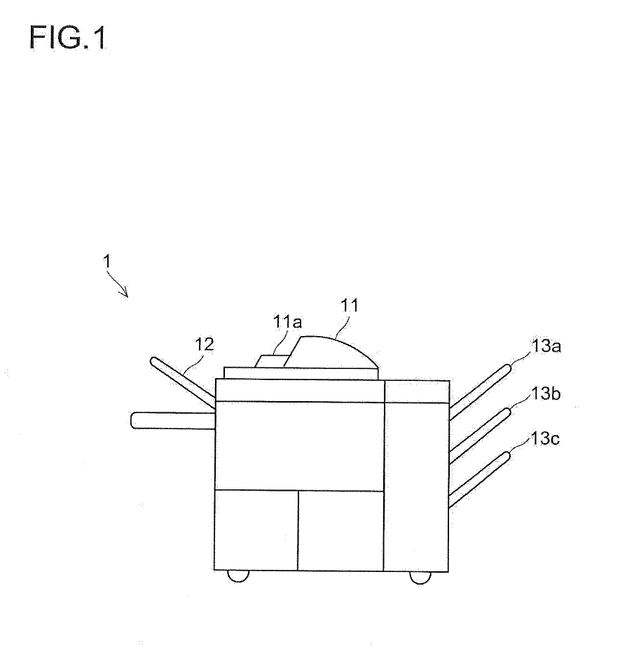

FIG. 1 shows the appearance of an image forming apparatus. In the image forming apparatus 1, a user operation portion 11 that includes a user authentication portion 11a, a reading feeder 12 and a plurality of trays 13 are provided. In the present embodiment, three trays are provided (which are represented by symbols 13a, 13b and 13c).

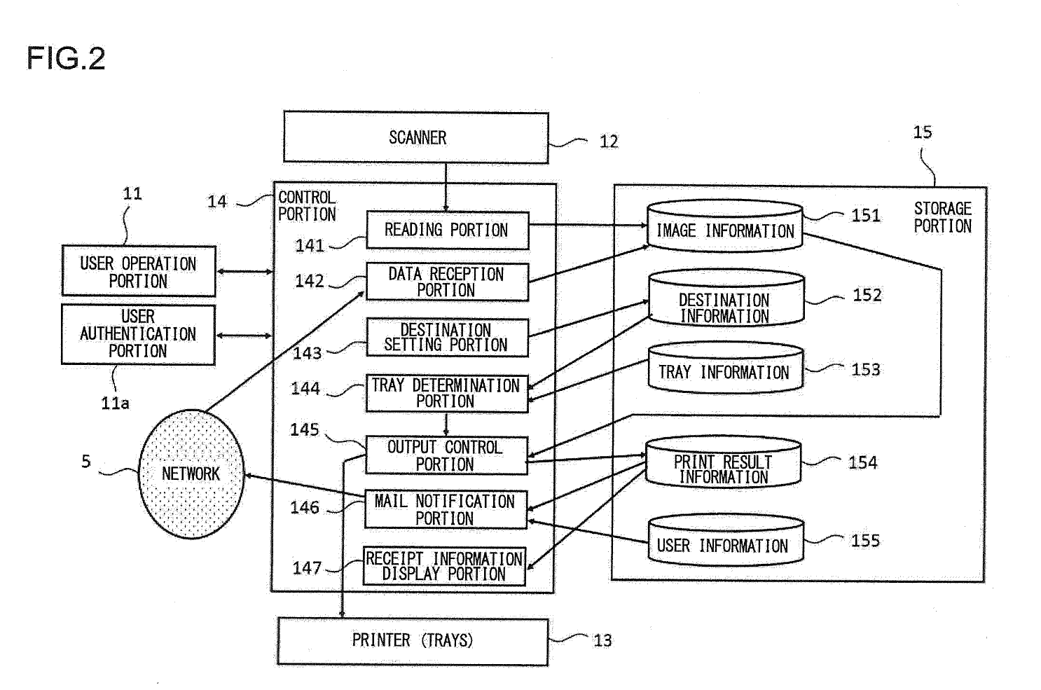

FIG. 2 shows the configuration of the image forming apparatus. The image forming apparatus 1 includes the user operation portion 11, the user authentication portion 11a, a scanner (reading feeder) 12, a printer (trays) 13, a control portion 14 and a storage portion 15.

The user operation portion 11 includes an input device such as a touch panel and a display device such as a LCD (Liquid Crystal Display). The user operation portion 11 receives an input by an operator and transfers an input signal to the individual portions of the control portion 14. In this way, the image forming apparatus 1 is operated by the operator.

The user authentication portion 11a is a reader such as a non-contact type card. Based on information recorded in the card, who is the user is authenticated.

The control portion 14 includes a reading portion 141, a data reception portion 142, a destination setting portion 143, a tray determination portion 144, an output control portion 145, a mail notification portion 146 and a receipt information display portion 147. The reading portion 141, the data reception portion 142, the destination setting portion 143, the tray determination portion 144, the output control portion 145, the mail notification portion 146 and the receipt information display portion 147 each include one or a plurality of circuits. Here, as the circuit, an electronic component or an electronic substrate, such as a processor such as a Central Processing Unit (CPU) or an Application Specific Integrated Circuit (ASIC), in which a plurality of electronic elements are connected by wiring can be used. Furthermore, the circuit can read and execute various types of programs and can also execute various types of programs that are previously incorporated therewithin. The data reception portion 142 and the mail notification portion 146 are connected to a network 5, and performs, through the network 5, data transmission and reception (including mail transmission and reception) with other devices.

The storage portion 15 is a nonvolatile memory that has a region where data is stored. The storage portion 15 stores image information 151, destination information 152, tray information 153, print result information 154 and user information 155.

The reading feeder (scanner) 12 is a device for converting a print product into image data. The reading feeder 12 is driven by the reading portion 141, and reads a print surface while transporting the print product placed on the reading feeder 12. The reading feeder 12 further stores image data on the read print surface, as the image information 151, in the storage portion 15.

The trays 13 output the print product. The printer is driven by the output control portion 145, the image information 151 is printed on a sheet and the printed sheet is output to the trays 13. The number of trays 13 is not one but the trays 13a, 13b and 13c that will be described later are present.

Data stored in the storage portion 15 will be briefly described below. The image information 151 is information on an image to be printed, and is data on an image that is read by the scanner 12, an image that is received by the data reception portion 142 or the like.

The destination information 152 is information that indicates who receives the print product.

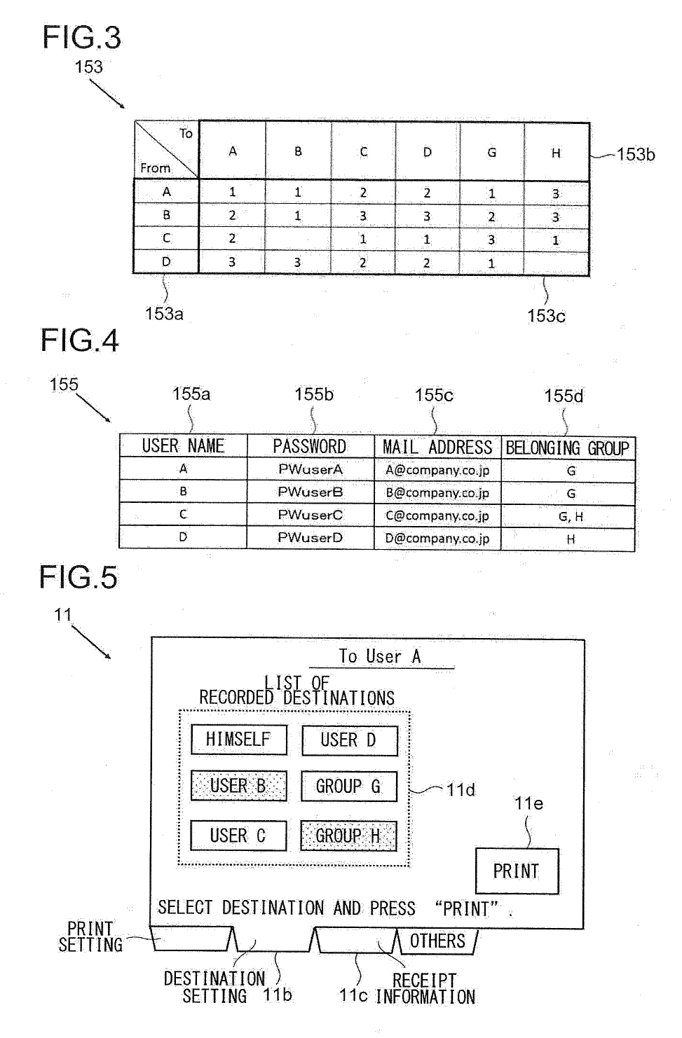

The tray information 153 holds, in a matrix format of an instructor 153a and a recipient 153b, a tray number 153c to which the print product is output. FIG. 3 shows an example of the tray information. Although blanks are present in the matrix of the figure, there is no problem thereon. For example, a user C himself chooses not to perform printing by setting a user B as the recipient.

The print result information 154 is information that indicates, for each user, to which one of the trays 13 the print product is output.

The user information 155 is information that includes a user name 155a, a password 155b, a mail address 155c and a belonging group 155d of each user. FIG. 4 shows an example of the user information. With respect to the belonging group 155d, as long as it is possible to determine a user who belongs to a group, instead of data for each user, as data for each group, belonging users may be held.

The functions of individual portions (other than the reading portion 141 that has been described above) included in the control portion will be briefly described below. The data reception portion 142 receives, from other devices, data to be printed and other pieces of data.

The destination setting portion 143 sets and updates the destination information 152 based on an instruction from the user.

The tray determination portion 144 references the tray information 153 to determine, from the instructor 153a and the recipient 153b, the tray number 153c to which the print product is output.

The output control portion 145 prints the image information 151 and outputs it to the printer 13. Here, the output control portion 145 outputs it to the tray that is determined by the tray determination portion 144. Moreover, information indicating to which one of the users the print product belongs and to which one of the trays the print product is output is stored as the print result information 154.

Based on the print result information 154, the mail notification portion 146 transmits, by mail, a notification of the information thereon to the user to which the print product to be received is output.

Based on the print result information 154, the receipt information display portion 147 displays, for each user, a list of the print products to be received and the trays to which the print products are output.

An example where print products are separately output to a plurality of trays will be described below utilizing the image forming apparatus 1.

For example, when a user copies a document, the reading feeder 12 is made to read the document to be copied, and the image information 151 is generated. On the other hand, when a user prints a file, the data reception portion 142 is made to receive data from a user terminal (not shown) through the network 5, and the image information 151 is generated. When the user copies the document, an instruction of the user is provided to the image forming apparatus by the operation of the user operation portion 11. On the other hand, when the user prints the file, the instruction is provided from the user terminal by access of the image forming apparatus 1 through the network 5.

In the following description, it is assumed that the user copies the document and operates the user operation portion 11. However, even when the file is printed, the same display as the display produced on the user operation portion 11 is produced in the user terminal, and thus communication can be performed, with the result that it is possible to perform the same processing.

The user information 155 and the tray information 153 can be naturally browsed and checked and edited as necessary. The image forming apparatus 1 includes a means (not shown) for browsing and editing the user information 155 and the tray information 153. It is assumed that the browsing and editing are performed by logging in to the image forming apparatus through authentication (by putting a user-specific card over the user authentication portion 11a or inputting a user ID and a password into the data reception portion 142). Here, for the user information 155, only data on the user who logs in thereto can be browsed and edited, and the tray information 153 can be browsed and edited only by the user who logs in thereto and who is the instructor. In this way, conditions in which a large number of users can perform the browsing and editing are avoided, and the problem when erroneous editing is performed and the problem on security are reduced.

For example, the control on the browsing and editing can be performed by another known method of dividing the user information 155 and the tray information 153 into user-specific files and using the access permission of the files. The users may be made to individually set passwords for the files.

A specific example where the image forming apparatus 1 is actually operated will be described below together with a user's act and processing by the image forming apparatus 1.

The user A is assumed to consider that the user B and a group H are made to receive a copy of his own material. The user A carries the material, moves to the image forming apparatus 1 and puts a card over the user authentication portion 11a. The image forming apparatus 1 produces a display on the user operation portion 11 for an operation by the user A.

FIG. 5 shows an example of a destination setting screen. In order for various types of operations to be performed in a limited area of the user operation portion 11, on the user operation portion 11, a plurality of tabs including a destination setting tab 11b and a receipt information tab 11c are displayed. When the user A selects the destination setting tab 11b, the destination setting portion 143 is started up, and the destination setting portion 143 displays the screen of FIG. 5 on the user operation portion 11. The destination setting portion 143 displays a destination selection region 11d and a print button 11e.

In the destination selection region 11d, the destination setting means (destination setting portion 143) references the tray information 153 to display a recipient who is selected by the user A (whose tray number is in the matrix of the tray information 153). The user A touches the destination to select one or a plurality of recipients. In the figure, the user B and the group H are selected and highlighted. The destination setting portion 143 stores the selected user and group as the destination information 152.

The user A sets the material on the reading feeder 12 and touches the print button 11e. In order to perform printing in which the user A is set to the instructor and the user B and the group H are set to the recipients, the control portion 14 starts up the tray determination portion 144 and the output control portion 145 in this order.

The tray determination portion 144 references the tray information 153 (see FIG. 3) and the user information 155 to determine the trays to which print products are output and the number of copies that need to be output to each of the trays. It is determined that (1) the print product in which the user B is the recipient is output to a first tray and the print product in which the group H is the recipients is output to a third tray and that (2) since two members of the user C and a user D belong to the group H, the number of copies of the print product in which the group H is the recipients is two. In this way, the tray determination portion 144 notifies the output control portion 145 that one copy of the print product needs to be output to the first tray and that two copies thereof need to be output to the third tray.

As the print products on the image information 151, the output control portion 145 outputs, to the first tray, the print product in which the user A is set to the instructor and the user B is set to the recipient and outputs, to the third tray, the print product in which the user C and the user D are the recipients. Then, the printed details are added to the print result information 154, and the mail notification portion 146 is started up.

The mail notification portion 146 transmits, to the user B, the user C and the user D, mail indicating that the print product in which the user A is set to the instructor needs to be received. Here, the user information 155 is referenced, and thus the mail addresses of the user B, the user C and the user D are determined.

The processing in which the instruction by the instructor (user A) is received to perform printing and the mail is transmitted to the recipients has been described above using the example of the copy printing. When a file is printed, substantially the same processing is performed. The user A inputs, from his own terminal device, a user ID and a password, and thereby can log in to the image forming apparatus 1. The image forming apparatus 1 can produce the same display as the user operation portion 11 on the terminal device, and can perform processing by clicking a mouse in the terminal device instead of touching on the user operation portion 11.

A procedure in which a print product in which another user is set to the instructor is received by the recipient will then be described. It is assumed that four pieces of mail indicating that the print product in which another user is set to the instructor needs to be received are received by the user A. The user A moves to the image forming apparatus 1 and puts the card over the user authentication portion 11 a.

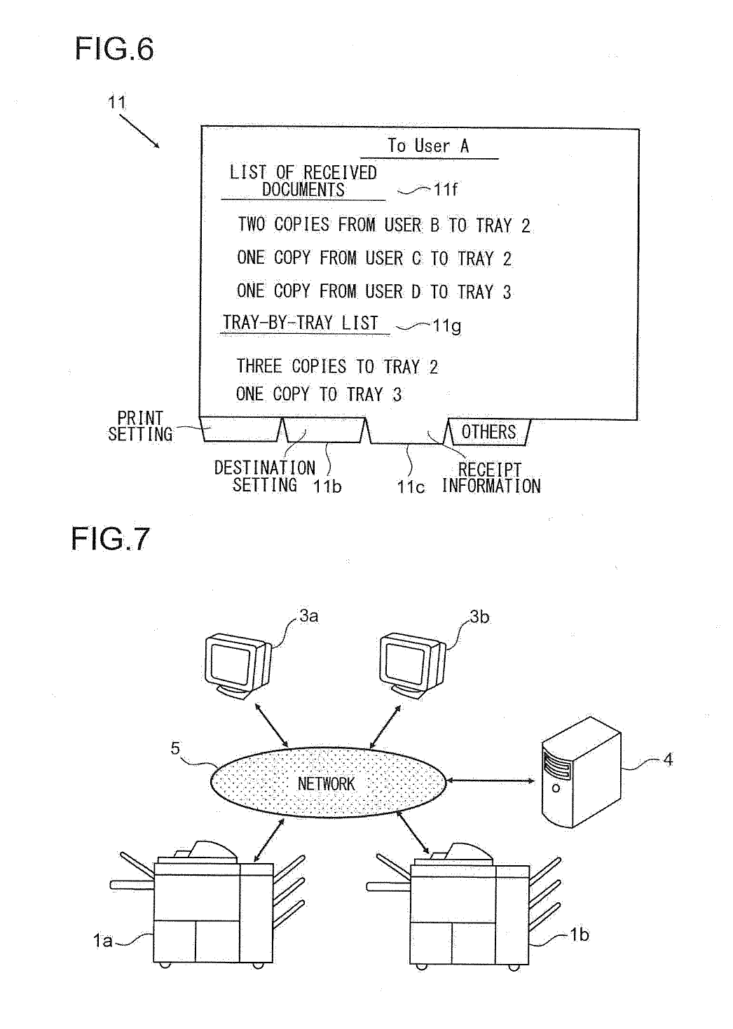

FIG. 6 shows an example of a receipt information display screen. When the user A selects the destination setting tab 11 b in the display on the user operation portion 11, the receipt information display portion 147 is started up, and the receipt information display portion 147 displays the screen of FIG. 5 on the user operation portion 11. The receipt information display portion 147 displays, on the receipt information display screen, information 11f on from which user the print product is received and how many copies thereof are received from such a user and information 11g on from which tray the print product is received and how many copies thereof are received from such a tray.

The receipt information display screen is displayed through referencing of the print result information 154 by the receipt information display portion 147. After the completion of the display, the receipt information display portion 147 deletes the display from the print result information 154. This is because the received print product will not be displayed in the future.

When a user who receives a large number of print products receives a large number of pieces of mail, it is complicated to correctly grasp from which users the print products are received, how many pieces thereof are received from such users, from which trays the print products are received and how many pieces thereof are received from such trays. With the receipt information display screen, the users can easily and reliably grasp print products that need to be received.

As described in detail above, the image forming apparatus 1 of the present embodiment is used, and thus it is possible to reduce the problems caused by the browsing and editing of data on the use of trays and to separately output print products to a plurality of trays. Then, it is possible to remove the complexity of users who receive the print products.

### Second Embodiment

In the present embodiment, a management server 4 is used, and print products are separately output to the trays of two or more image forming apparatuses 1. The user information 155 and the tray information 153 are assumed to be stored in the management server 4. The tray number 153c is assumed to be information that indicates which one of the image forming apparatuses and which tray in such an image forming apparatus.

FIG. 7 shows the configuration of an image forming system. Two or more image forming apparatuses 1 (which are represented by symbols 1a and 1b in the figure but the number of image forming apparatuses 1 is not limited as long as the number thereof is two or more), user terminals 3 (which are two user terminals and which are represented by symbols 3a and 3b in the figure but the number of user terminals 3 is not limited) and the management server 4 are connected through the network 5. The image forming system is formed with two or more image forming apparatuses 1 and the management server 4 connected through the network 5.

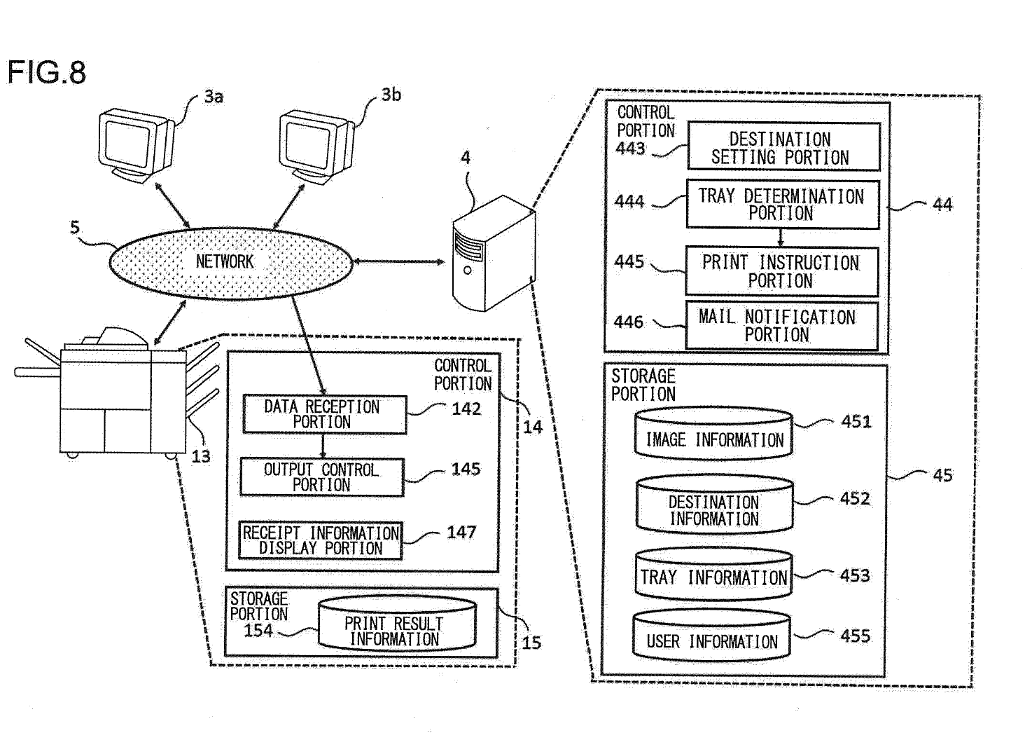

FIG. 8 shows the details of the image forming system. FIG. 8 is a diagram showing the details of the configuration of the management server 4 and the image forming apparatus 1a in FIG. 7. Since the image forming apparatus 1b is the same as the image forming apparatus 1a, the image forming apparatus 1b is omitted.

The management server 4 includes a control portion 44 and a storage portion 45. The image forming apparatus 1a includes the control portion 14 and the storage portion 15. FIG. 8 and FIG. 2 are compared with each other in the control portion 14 and the storage portion 15.

In FIG. 8, the control portion 14 does not include the destination setting portion 143, the tray determination portion 144 and the mail notification portion 146. These functions are included, in the control portion 44 of the management server 4, as a destination setting portion 443, a tray determination portion 444 and a mail notification portion 446. In other words, the functions are transferred from the image forming apparatus la to the management server 4.

The data reception portion 142, the output control portion 145 and the receipt information display portion 147 that are common to FIG. 8 and FIG. 2 have the same functions. However, instead of reading the image information 151 and receiving the notification of the tray number from the tray determination portion 144, the output control portion 145 receives the information from the data reception portion 142.

In FIG. 8, the storage portion 15 does not include the image information 151, the destination information 152, the tray information 153 and the user information 155. The information is stored, in the storage portion 45 of the management server 4, as image information 451, destination information 452, tray information 453 and user information 455. The print result information 154 that is common to FIG. 8 and FIG. 2 is the same information.

A specific example where the image forming system is actually operated will be described below.

The user A is assumed to consider that the user B and the group H are made to receive the print product of his own file. The user A logs in to the management server 4 from his own user terminal 3a, specifies the destination and transmits, to the management server 4, information that it is desired to print the file and the file to be printed.

In the management server 4, the same screen as FIG. 5 in the first embodiment is displayed on the user terminal 3a. Thereafter, as in the first embodiment, the destination is set by the destination setting portion 443. The tray determination portion 444 determines an image forming apparatus and a tray to which the print product needs to be output. In the present embodiment, it is assumed that for the user B, the print product is output to the first tray of the image forming apparatus 1a, and that for the group H, the print product is output to the third tray of the image forming apparatus 1b.

A print instruction portion 445 transmits, to the image forming apparatus 1a, a file to be printed or an image to be printed that is formed from its file, together with information that the user A is set to the instructor and the user B is set to the recipient. In the image forming apparatus 1a, the data reception portion 142 receives the image to be printed and the information on the tray to which the print product needs to be output, and the output control portion 145 prints and outputs one copy to the first tray.

The print instruction portion 445 also transmits, to the image forming apparatus 1b, a file to be printed or an image to be printed that is formed from its file, together with information that the user A is set to the instructor and the group H is set to the recipients. In the image forming apparatus 1b, the data reception portion 142 receives the image to be printed and the information on the tray to which the print product needs to be output, and the output control portion 145 prints and outputs two copies to the third tray.

As in the first embodiment, the mail notification portion 446 transmits, to the user B, the user C and the user D, mail indicating that the print product in which the user A is set to the instructor needs to be received.

The receipt of the print product can also be performed as in the first embodiment with the print result information 154 held in the image forming apparatuses 1a and 1b.

The example where the user A provides the instruction from the user terminal 3a is described above. The same instruction can be provided from the image forming apparatus 1a or 1b. Preferably, as in the first embodiment, the image forming apparatus 1a or 1b operates the destination setting means (destination setting portion) and transmits the set destination to the management server 4 instead of providing the instruction to the output control portion 145 of the own apparatus.

As described in detail above, the image processing system of the present embodiment is used, and thus it is possible to reduce the problems caused by the browsing and editing of data on the use of trays and to separately output print products to a plurality of trays in a plurality of image forming apparatuses.

In order to easily grasp who is the recipient of the print product, a cover page may be added to the print product, and information, such as the name of the recipient, for identifying the recipient may be printed on the cover page. The processing described above can be performed by the output control portion 145.

As described above, the image forming apparatus of the present disclosure includes: a plurality of trays 13; the output control portion 145 that selects one of the trays 13 and outputs the print product; the storage portion 15 that stores the tray information for determining a tray with a combination between the instructor who provides an instruction of printing and the recipient who receives the print product; and the tray determination portion 144 that determines, with the tray information, the tray 13 to be selected by the output control portion 145. In the feature described above, the data indicating the correspondence between the recipient and the tray is separated for each of the instructors. It is possible to hold the data while avoiding the conditions in which a large number of users can perform browsing and editing.

In the image forming apparatus 1 of the present disclosure, the tray information is classified for each of the instructors, and the classifications can be browsed and edited only by the instructor. In the feature described above, the browsing and editing can be performed only by the instructor, and thus the problem when erroneous editing is performed and the problem on security are reduced.

The image forming apparatus 1 of the present disclosure includes the mail notification portion 146 that notifies the recipient by mail that the print product is output. In the feature described above, it is possible to reliably notify the recipient by mail.

The image forming apparatus 1 of the present disclosure includes the destination setting portion 143 with which the instructor specifies the recipient. In the feature described above, the instructor can specify the recipient for each of the print products.

The image forming apparatus 1 of the present disclosure includes the receipt information display portion 147 that displays, for the recipient, a list of print products that have been output from one or two or more of the instructors and trays to which the print products are output. In the feature described above, the recipient can easily and reliably grasp the tray to which the print product to be received by the recipient is output.

When print products that have been output from two or more instructors are received, there is a possibility that the print products are output to two or more trays, and thus it is useful to display the list of the trays. Although in a conventional image forming apparatus, in a job reservation mode, one tray to which paper is ejected is displayed, in the present disclosure, even two or more copies of print products that are output to two or more trays are displayed and thus a guidance is provided.

The image forming system of the present disclosure includes: one or two or more image forming apparatuses; and the management server 4, where one of the image forming apparatuses and one of the trays in the one image forming apparatus are specified, the one image forming apparatus is instructed to perform printing, the tray information that corresponds to an image forming apparatus and a tray corresponding to a combination between an instructor who provides an instruction of the printing and a recipient who receives the print product is used to determine the image forming apparatus 1 and the tray 13 specified by the print instruction portion 445 and the print product is output. In the image forming system, the management server 4 is used, and thus the image forming system using two or more image forming apparatuses 1 is formed. The two or more image forming apparatuses 1 can also be installed in places apart from each other, with the result that wider utilization can be performed.

An image forming method of the present disclosure is an image forming method in the image forming system described above, and includes: using the management server 4 to control one or two or more image forming apparatuses 1 so as to select one of the trays and output the print product; determining the tray 13 to be selected by the output control portion 145 with the tray information that indicates the image forming apparatus 1 and the tray 13 corresponding to the combination between the instructor who provides the instruction of the printing and the recipient who receives the print product; and outputting the print product according to the instruction provided by the print instruction portion 445.

According to the present disclosure, there are provided an image forming apparatus that separately outputs print products to a plurality of trays and reduces problems caused by browsing and editing of data on the use of the trays, an image forming system that utilizes the image forming apparatus through a network and an image forming method. It can be considered that a large number of companies can utilize them

What is claimed is:

1. An image forming apparatus comprising:
a plurality of trays;
an output control circuit that selects one of the trays and outputs a print product;
a storage circuit that stores tray information indicating a tray corresponding to a combination between an instructor who provides an instruction of printing and a recipient who receives the print product; and
a tray determination circuit that determines, with the tray information, the tray to be selected by the output control circuit.

2. The image forming apparatus according to claim 1,
wherein the tray information is classified for each of the instructors, and can be browsed and edited only by the instructor corresponding to each of the classifications.

3. The image forming apparatus according to claim 1, further comprising:
a mail notification circuit that notifies the recipient by mail that the print product is output.

4. The image forming apparatus according to claim 1, further comprising:
a destination setting circuit that sets the recipient specified by the instructor.

5. The image forming apparatus according to claim 1, further comprising:
a receipt information display circuit that displays, for the recipient, a list of print products that have been output from one or two or more of the instructors and trays to which the print products are output.

6. The image forming apparatus according to claim 1,
wherein the tray information is classified for each of the instructors, and can be browsed and edited only by the instructor corresponding to each of the classifications, and
the image forming apparatus includes:
a mail notification circuit that notifies the recipient by mail that the print product is output;
a destination setting circuit that sets the recipient specified by the instructor; and
a receipt information display circuit that displays, for the recipient, a list of print products that have been output from one or two or more of the instructors and trays to which the print products are output.

7. An image forming system comprising:
one or two or more image forming apparatuses; and
a management server,
wherein the image forming apparatus includes:
a plurality of trays; and
an output control circuit that selects one of the trays and outputs a print product,
the management server includes:
a print instruction circuit that specifies one of the image forming apparatuses and one of the trays in the one image forming apparatus and instructs the one image forming apparatus to perform printing;
a storage circuit that stores tray information that corresponds to an image forming apparatus and a tray corresponding to a combination between an instructor who provides an instruction of the printing and a recipient who receives the print product; and
a tray determination circuit that determines, with the tray information, the image forming apparatus and the tray to be specified by the print instruction circuit and
the output control circuit outputs the print product according to the instruction provided by the print instruction circuit.

8. An image forming method in the image forming system according to claim 7, the image forming method comprising:
using the management server to control one or two or more image forming apparatuses so as to select one of the trays and output the print product;
determining the tray to be selected by the output control circuit with the tray information that indicates the image forming apparatus and the tray corresponding to the combination between the instructor who provides the instruction of the printing and the recipient who receives the print product; and
outputting the print product according to the instruction provided by the print instruction circuit.
